(19) United States
(12) Patent Application Publication
(10) Pub. No.: US 2012/0291747 A1
(43) Pub. Date: Nov. 22, 2012

(54) INTERNAL COMBUSTION ENGINE FUEL SUPPLY SYSTEM

(75) Inventors: Ralph Jurjevec, Wien (AT); Roland Ennsmann, Gunskirchen (AT); Gunther Zauner, Peuerbach (AT); Jean-Charles Pouillard, Krengbach (AT)

(73) Assignee: BRP-POWERTRAIN GMBH & CO. KG, Gunskirchen (AT)

(21) Appl. No.: 13/574,934

(22) PCT Filed: Jan. 28, 2011
(86) PCT No.: PCT/EP2011/051273

§ 371 Date: Jul. 24, 2012

Related U.S. Application Data
(60) Provisional application No. 61/299,694, filed on Jan. 29, 2010.

(51) Int. Cl. F02M 59/10; F02M 39/02

(52) U.S. Cl. 123/294; 123/508

(57) ABSTRACT

An internal combustion engine has a fuel supply system which has a fuel pump driving mechanism that limits the relative motion between a part of the mechanism contacting a plunger of the pump and the plunger.

### CROSS-REFERENCE

The present application claims priority to U.S. Provisional Patent Application No. 61/299,694, filed Jan. 29, 2010 the entirety of which is incorporated herein by reference.

### FIELD OF THE INVENTION

The present invention relates to internal combustion engine fuel supply systems and to engines incorporating such systems.

### BACKGROUND

Many internal combustion engines use a fuel pump which consists of a piston reciprocating inside the housing of the pump between two positions. A spring biases the piston towards one of the two positions. A plunger is connected to the piston and extends from the pump housing. In order to actuate the pump a cam connected to a rotating shaft of the engine comes into contact with the end of the plunger. As the cam rotates, the plunger reciprocates and as a result, causes the piston to reciprocate.

In order to prevent wear of the cam and of the plunger due to friction between the two parts, lubricant needs to be supplied between these two parts. In four-stroke engines, this can be easily achieved since the engine is typically lubricated using pressurized lubricant, and as such, lubricant can be injected between the cam and the plunger. However, two-stroke engines do not use pressurized lubricant to lubricate the various components of the engine, which makes supplying lubricant between the cam and the plunger more difficult.

In addition to causing wear of the cam and the plunger, the friction between these two parts also causes side forces to be transmitted to the piston. The side forces cause the piston to press against the inner wall of the pump which causes friction and therefore wear of these parts of the pump.

Also, when the pressure at which fuel needs to be supplied increases, the forces that need to be applied to the plunger in order to cause it to reciprocate also increase. As a result, the friction between the cam and the plunger increases which accelerates the wear of the cam and the plunger.

Therefore, there is a need for an internal combustion engine having a fuel supply system which has fuel pump driving mechanism that limits the wear of the parts of the mechanism and of the pump.

### SUMMARY

It is an object of the present invention to ameliorate at least some of the inconveniences present in the prior art.

It is also an object of the present invention to provide an internal combustion engine having a fuel supply system which has a fuel pump driving mechanism that limits the relative motion between a part of the mechanism contacting a plunger of the pump and the plunger, thus limiting the wear of the pump, the part of the mechanism contacting the plunger and the plunger.

In one embodiment, a bearing is disposed around an eccentric shaft driving the pump and an outer race of the bearing contacts the end of the plunger of the pump.

In another embodiment, a lever has an end contacting the end of the plunger of the pump. A cam moves the lever such that the lever drives the pump. The cam and the lever are arranged such that the end of the lever moves generally parallel to an axis of the plunger.

In one aspect, the invention provides an internal combustion engine having at least one cylinder, at least one piston disposed in the cylinder, the at least one cylinder and the at least one piston defining at least in part at least one combustion chamber, a crankshaft operatively connected to the at least one piston, at least one fuel injector fluidly communicating with the at least one combustion chamber, and a fuel pump fluidly communicating with the at least one fuel injector. The fuel pump includes a pump piston movable between a first and a second position, a plunger connected to the pump piston, and a spring biasing the pump piston toward the first position. An eccentric shaft has a first cylindrical surface having a first central axis and a second cylindrical surface having a second central axis. The second central axis is offset from the first central axis. The eccentric shaft is operatively driven by the crankshaft such that the eccentric shaft rotates about the first central axis. At least one bearing has an inner race disposed on the eccentric shaft around the second cylindrical surface and an outer race abutting an end of the plunger such that as the eccentric shaft rotates, the at least one bearing moves the pump piston between the first and the second position.

In an additional aspect, the eccentric shaft has a third cylindrical surface having a third central axis. The third central axis is co-axial with the first central axis. The second cylindrical surface is disposed between the first and the third cylindrical surfaces.

In a further aspect, a shaft is operatively connected to the crankshaft and is disposed generally perpendicular to the crankshaft. The eccentric shaft is operatively driven by the shaft.

In an additional aspect, the eccentric shaft is coaxial with the shaft.

In a further aspect, a water pump is driven by the shaft.

In an additional aspect, the eccentric shaft and the crankshaft rotate at a same speed.

In a further aspect, the fuel pump is a high pressure fuel pump adapted to pressurize fuel at a pressure exceeding 70 bar.

In an additional aspect, the fuel pump is adapted to pressurize fuel between a minimum pressure of 20 bar and a maximum pressure exceeding 200 bar.

In a further aspect, the engine is a direct fuel injection two-stroke engine.

In an additional aspect, the at least one cylinder is at least two cylinders, the at least one piston is at least two pistons, the at least one combustion chamber is at least two combustion chambers, and the at least one fuel injector is at least two fuel injectors. A fuel rail has one inlet fluidly connected to the fuel pump and at least two outlets fluidly connected to the at least two fuel injectors.

In a further aspect, the fuel pump includes an intake valve for opening and closing a fuel inlet port of the fuel pump. An amount of fuel pressure generated by the fuel pump is controlled by adjusting a closing time of the intake valve.

In an additional aspect, a fuel line fluidly communicates the fuel pump with the at least one fuel injector. A control valve fluidly communicates with the fuel line. The control valve fluidly communicates the fuel line with a fuel tank when the pressure of fuel being supplied to the at least one fuel injector is above a desired fuel pressure.

In a further aspect, a fuel line fluidly communicates the fuel pump with the at least one fuel injector. An other fuel injector is fluidly connected to the fuel line. The other injector pumps fuel away from the fuel line to a fuel tank when the pressure of fuel being supplied to the at least one fuel injector is above a desired fuel pressure.

In another aspect, the invention provides an internal combustion engine having at least one cylinder, at least one piston disposed in the cylinder, the at least one cylinder and the at least one piston defining at least in part at least one combustion chamber, a crankshaft operatively connected to the at least one piston, at least one fuel injector fluidly communicating with the at least one combustion chamber, and a fuel pump fluidly communicating with the at least one fuel injector. The fuel pump includes a pump piston movable between a first and a second position, a plunger connected to the pump piston, and a spring biasing the pump piston toward the first position. A cam is operatively driven by the crankshaft such that the cam rotates about a first axis. A roller abuts the cam such that the cam moves the roller between a third and a fourth position as the cam rotates. A lever is rotatably connected to the roller about a second axis. The lever has a first end abutting an end of the plunger such that as the cam moves the roller between the third and the fourth position, the first end of the lever moves the pump piston between the first and the second position.

In an additional aspect, the lever has a second end extending on a side of the second axis opposite the first end of the lever. The second end of the lever pushes against a surface of the engine as the cam moves the roller between the third and the fourth position.

In a further aspect, a ball is disposed between the second end of the lever and the surface of the engine.

In an additional aspect, the first end of the lever has a recessed portion. The end of the plunger is received in the recessed portion.

In a further aspect, a balancer shaft is operatively connected to the crankshaft. The cam is disposed on the balancer shaft.

In an additional aspect, the fuel pump is a high pressure fuel pump adapted to pressurize fuel at a pressure exceeding 70 bar.

In a further aspect, the fuel pump is adapted to pressurize fuel between a minimum pressure of 20 bar and a maximum pressure exceeding 200 bar.

In an additional aspect, the engine is a direct fuel injection two-stroke engine.

In a further aspect, the at least one cylinder is at least two cylinders, the at least one piston is at least two pistons, the at least one combustion chamber is at least two combustion chambers, and the at least one fuel injector is at least two fuel injectors. A fuel rail has one inlet fluidly connected to the fuel pump and at least two outlets fluidly connected to the at least two fuel injectors.

In an additional aspect, the fuel pump includes an intake valve for opening and closing a fuel inlet port of the fuel pump. An amount of fuel pressure generated by the fuel pump is controlled by adjusting a closing time of the intake valve.

In a further aspect, a fuel line fluidly communicates the fuel pump with the at least one fuel injector. A control valve fluidly communicates with the fuel line. The control valve fluidly communicates the fuel line with a fuel tank when the pressure of fuel being supplied to the at least one fuel injector is above a desired fuel pressure.

In an additional aspect, a fuel line fluidly communicates the fuel pump with the at least one fuel injector. An other fuel injector is fluidly connected to the fuel line. The other injector pumps fuel away from the fuel line to a fuel tank when the pressure of fuel being supplied to the at least one fuel injector is above a desired fuel pressure.

Embodiments of the present invention each have at least one of the above-mentioned objects and/or aspects, but do not necessarily have all of them. It should be understood that some aspects of the present invention that have resulted from attempting to attain the above-mentioned objects may not satisfy these objects and/or may satisfy other objects not specifically recited herein.

Additional and/or alternative features, aspects, and advantages of embodiments of the present invention will become apparent from the following description, the accompanying drawings, and the appended claims.

### BRIEF DESCRIPTION OF THE DRAWINGS

For a better understanding of the present invention, as well as other aspects and further features thereof, reference is made to the following description which is to be used in conjunction with the accompanying drawings, where:

FIG. 1 is a schematic illustration of a fuel system for an engine according to the present invention;

FIG. 2 is a perspective view taken from a rear, left side of a portion of an engine according to the present invention;

FIG. 3 is a perspective view taken from a rear, right side of a portion of the engine of FIG. 2;

FIG. 4 is a perspective view of a fuel pump mounting flange of the engine of FIG. 2;

FIG. 5 is a cross-sectional view of a fuel pressure control adaptor of the fuel system of FIG. 1;

FIG. 6 is a bottom view of a fuel rail of the engine of FIG. 2;

FIG. 7 is a cross-sectional view of a portion of the engine of FIG. 2 taken perpendicularly to a crankshaft of the engine and through an axis of rotation of a water pump shaft of the engine showing a first embodiment of a pump driving mechanism of the engine of FIG. 2, an interior of a fuel pump of the engine being shown schematically;

FIG. 8 is a perspective view of an eccentric shaft used in the first embodiment of the pump driving mechanism shown in FIG. 7;

FIG. 9 is a view of a first end of the eccentric shaft of FIG. 8;

FIG. 10 is a view of a second end of the eccentric shaft of FIG. 8;

FIG. 11 is a schematic illustration of a second embodiment of a pump driving mechanism of the engine of FIG. 2;

FIG. 12 is a cross-sectional view of a portion of the second embodiment of the pump driving mechanism of FIG. 11 taken through line A-A of FIG. 11; and

FIG. 13 is a schematic illustration of an alternative embodiment of the pump driving mechanism of FIG. 7.

### DETAILED DESCRIPTION

The invention will now be described with respect to a direct injection, two-stroke engine 10 having a high pressure fuel pump 12 capable of supplying fuel at pressures in excess of 70 bar, since the above-mentioned problem are more likely to occur in such an arrangement. However, it is contemplated that the invention could also be used in four-stroke engines, with engines having a fuel pump having a lower maximum fuel supply pressure, and/or with engines having fuel supplied to its combustion chamber(s) by systems other than a direct injection system, such as a semi-direct injection system.

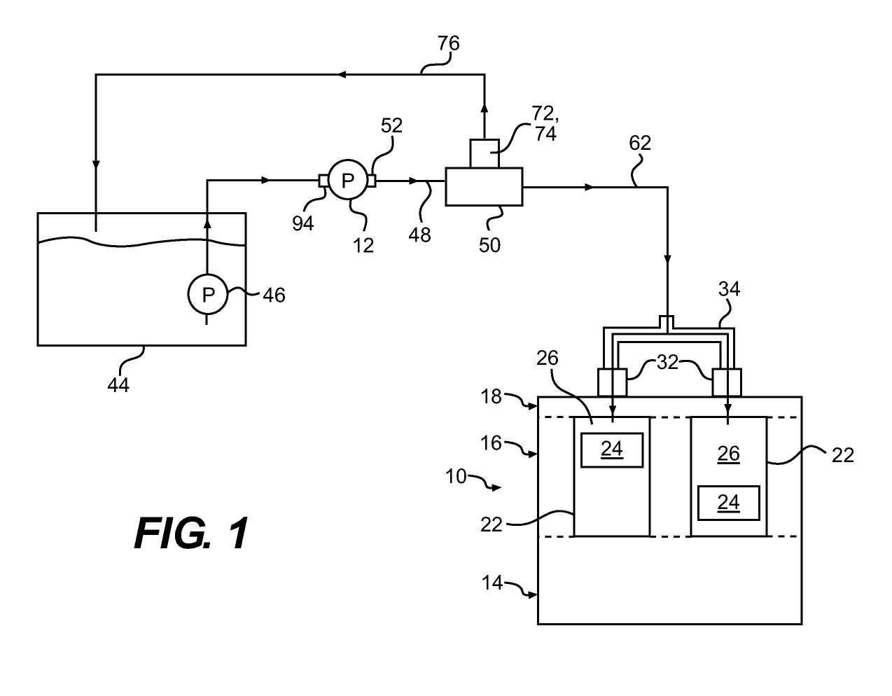

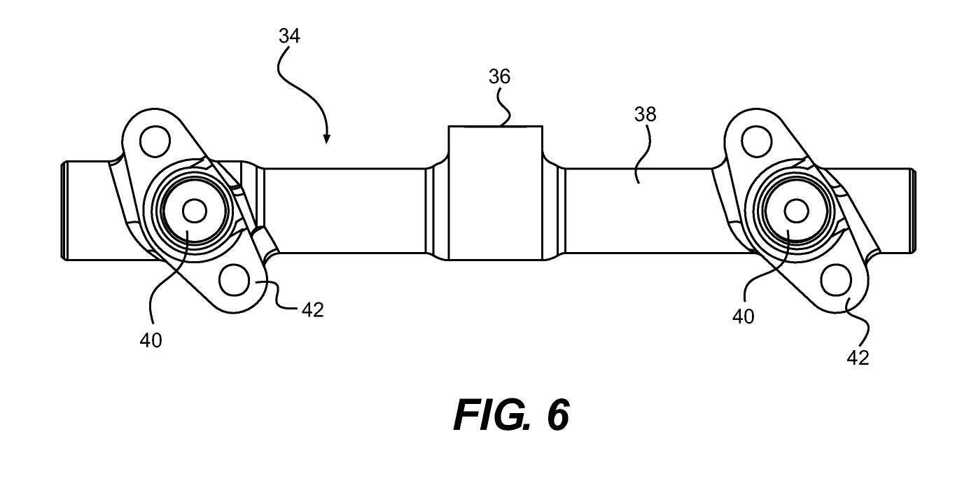

As seen in FIGS. 1 to 3, the engine 10 has a crankcase 14, a cylinder block 16, and a cylinder head 18. A crankshaft 20 is disposed inside the crankcase 14 to rotate therein and extends through a wall of the crankcase 14 to be operatively connected to an element to be driven by the engine 10, such as a wheel of a motorcycle or an endless track of a snowmobile. The cylinder block 16 defines two cylinders 22 (schematically shown in FIG. 1) therein. Two pistons 24 (schematically shown in FIG. 1) are disposed inside the cylinders 22 to reciprocate therein. The pistons 24 are connected to the crankshaft 20 via connecting rods (not shown) to drive the crankshaft 20. The cylinder head 18, the cylinders 22, and the pistons 24 define two combustion chambers 26 (schematically shown in FIG. 1). Two throttle bodies 28 are connected to one side of the cylinder block 16 to supply air to the combustion chambers 26. An exhaust manifold 30 is connected to another side of the cylinder block 16 to receive exhaust gases from the combustion chambers 26 resulting from the combustion process occurring therein. Two fuel injectors 32 (schematically shown in FIG. 1) are connected to the cylinder head 18 to supply fuel to the combustion chambers 26. A fuel rail 34 is connected to the cylinder head 18 to supply fuel to the fuel injectors 32 as described in greater detail below. As best seen in FIG. 6, the fuel rail 34 has a single inlet 36 connected to a center of the tube 38 and two outlets 40 connected near the ends of the tube 38. The outlets 40 are disposed at an angle to the inlet 36. The inlet 36 fluidly communicates with the fuel pump 12 and the outlets 40 fluidly communicate with the fuel injectors 32. Flanges 42 are provided around the outlets 40 to permit the attachment of the fuel rail 34 to the cylinder head 18. The engine 10 also has other components known to those skilled in the art, such as spark plugs, but since these are not believed to be necessary to the understanding of the present invention, they will not be described herein.

It is contemplated that the engine 10 could have only one or more than two cylinders 22. As should be understood, the engine 10 would then have a corresponding number of pistons 24, combustion chambers 26, throttle bodies 28 and fuel injectors 32. In cases where the engine 10 has more than two cylinders 22, the fuel rail 34 would have a corresponding number of outlets 40, it is however contemplated that the fuel rail 34 could be omitted should the engine 10 have only a single cylinder 22. It is contemplated that more than one fuel injector 32 could be provided per cylinder 22, in which case the fuel rail 34 would have a number of outlets 40 corresponding to the number of fuel injectors 32. It is also contemplated that the engine 10 could have less throttle bodies 28 than cylinders 22, such that each throttle body 28 would supply air to more than one combustion chamber 26.

The fuel system of the engine 10 will now be described with reference to FIGS. 1 to 3. Fuel to be supplied to the engine 10 is stored in a fuel tank 44. A pump 46 disposed inside the fuel tank 44 pumps fuel from the fuel tank 44 to the fuel pump 12. The pump 46 supplies fuel to the fuel pump 12 at a pressure of about 3 bar, but other pressures are contemplated. The fuel pump 12 then further pressurizes the fuel. The pressure at which the fuel pump 12 pressurizes the fuel is determined by an electronic control unit (ECU, not shown) of the engine 10 based on data such as engine speed and atmospheric pressure. The manner in which the pressure at which fuel is supplied from the fuel pump 12 is controlled will be described below. As previously mentioned, the fuel pump 12 is a high pressure fuel pump capable of supplying fuel at pressures in excess of 70 bar. It is contemplated that the fuel pump 12 could supply fuel at pressures exceeding 150 or even 250 bar. It has been found that by supplying fuel to the engine 10 at higher pressures, the mixing of air and fuel in the combustion chambers 26 prior to ignition is improved, resulting in a more homogeneous combustion. This leads to reduced fuel consumption and exhaust emissions. Supplying fuel to the engine 10 at higher pressures also reduces injection time per cycle, which allows for better control and flexibility of the injection event such as by allowing multiple injections per cycle for example. From the fuel pump 12, fuel flows in a fuel line 48 to a fuel pressure control adaptor 50. A check valve 52 (schematically shown in FIG. 1) is provided at an outlet of the fuel pump 12 to prevent fuel from returning inside the fuel pump 12 from the fuel line 48.

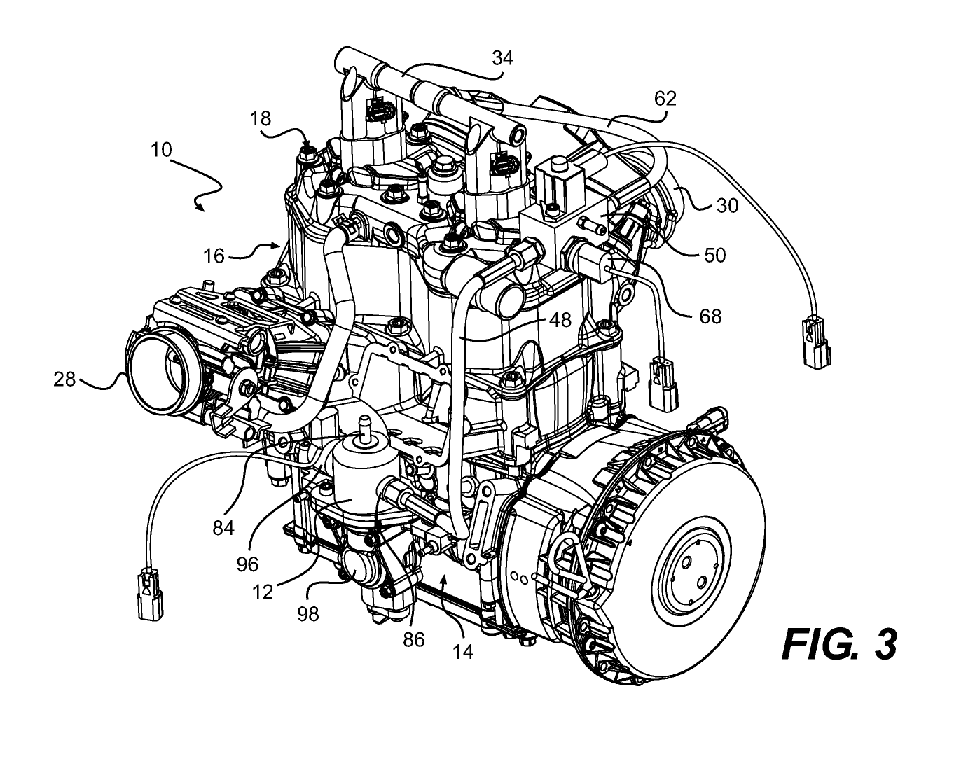

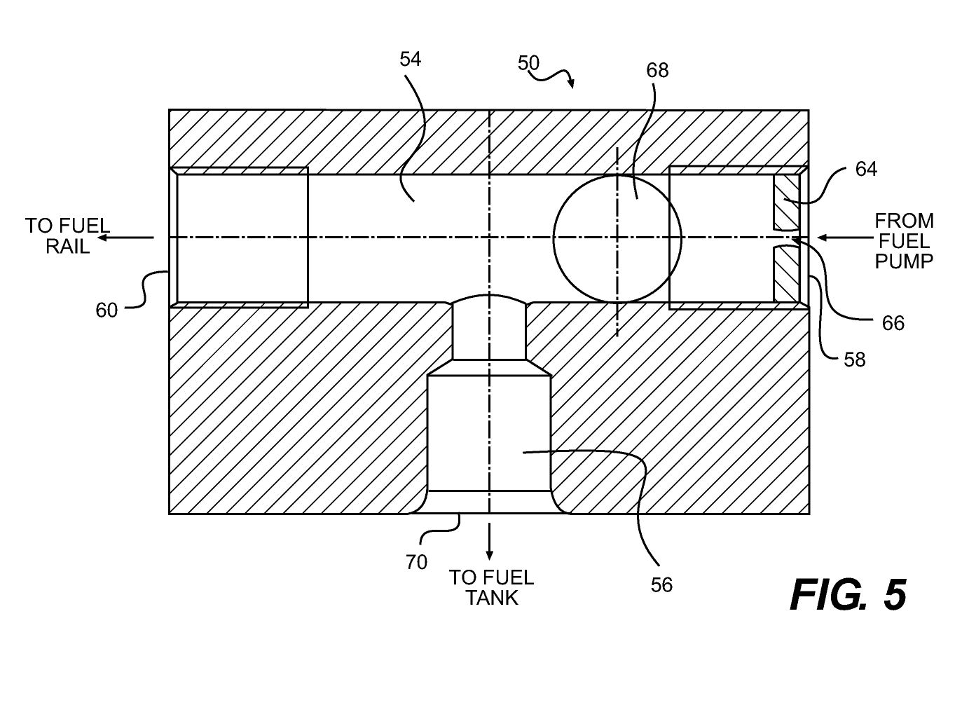

As seen in FIG. 5, the fuel pressure control adaptor 50 has a main passage 54 and a bypass passage 56 connected perpendicularly to the main passage 54. An inlet 58 of the main passage 54 is connected to the fuel line 48. An outlet 60 of the main passage 54 is connected to a fuel line 62 (FIGS. 1 and 3). A plug 64 is screwed inside the inlet 58. As can be seen, the plug 64 has an aperture 66. The small size of the aperture 66 decouples the fuel line 48 from pressure fluctuations resulting from the injection of fuel by the fuel injectors 32. However, the size of the aperture is selected to be large enough to prevent or at least minimize head loss across the aperture 66. A pressure sensor 68 connected to the fuel pressure control adaptor 50 senses the fuel pressure downstream of the plug 64. An outlet 70 of the bypass passage 56 is connected to one of a control valve 72 and a fuel injector 74 (schematically shown in FIG. 1), which is connected to a fuel line 76. The fuel pressure control adaptor 50 is preferably not rigidly connected to the engine 10 so as to decouple the fuel pressure control adaptor 50 from engine vibrations. For example, when the engine 10 is disposed in a vehicle, the fuel pressure control adaptor 50 could be connected to a frame of the vehicle.

In an embodiment using the control valve 72, when the fuel pressure sensed by the pressure sensor 68 is at or below a desired fuel pressure to be supplied to the fuel injectors 32 determined by the ECU, the valve 72 is closed, preventing fuel from flowing out of the adaptor 50 via the outlet 70. Fuel flows from the fuel pressure control adaptor 50 to the fuel line 62, then to the fuel rail 34 and fuel injectors 32, and finally to the combustion chambers 26. When the fuel pressure sensed by the pressure sensor 68 is above the desired fuel pressure to be supplied to the fuel injectors 32 determined by the ECU, the valve 72 is opened. Fuel then flows out of the adaptor 50 via the outlet 70 to the fuel line 76 which returns fuel to the fuel tank 44, thus relieving the excess fuel pressure.

In an embodiment using the fuel injector 74, when the fuel pressure sensed by the pressure sensor 68 is at or below the desired fuel pressure to be supplied to the fuel injectors 32 determined by the ECU, the fuel injector 74 is not operated, preventing fuel from flowing out of the adaptor 50 via the outlet 70. Fuel then flows to the combustion chambers 26 as described above. When the fuel pressure sensed by the pressure sensor 68 is above the desired fuel pressure to be supplied to the fuel injectors 32 determined by the ECU, the fuel injector 74 is operated. The fuel injector 74 pumps fuel out of the adaptor 50 (and fuel lines 48, 62) via the outlet 70 to the fuel line 76 which returns fuel to the fuel tank 44, thus relieving the excess fuel pressure. Since the fuel injector 74 actively permits the removal of fuel from the adaptor 50 (i.e. by pumping), this embodiment relieves the excess fuel pressure faster than the embodiment using the valve 72. It is contemplated that the fuel injector 74 could be replaced by a pump.

In an alternative embodiment (not shown), the valve 72 or injector 74 is replace by a valve disposed at the outlet of the fuel pump which, depending on the fuel pressure sensed by the pressure sensor 68, selectively allows fuel to flow from the fuel pump 12 to the adaptor 50 or back to the fuel tank 44.

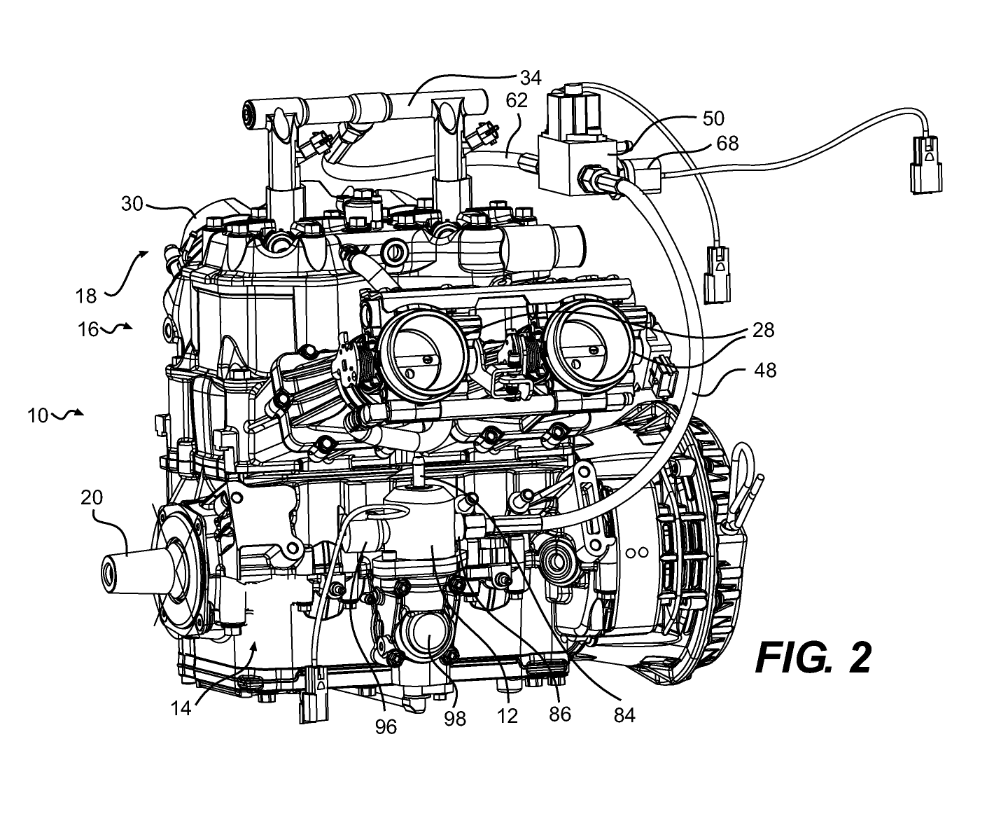

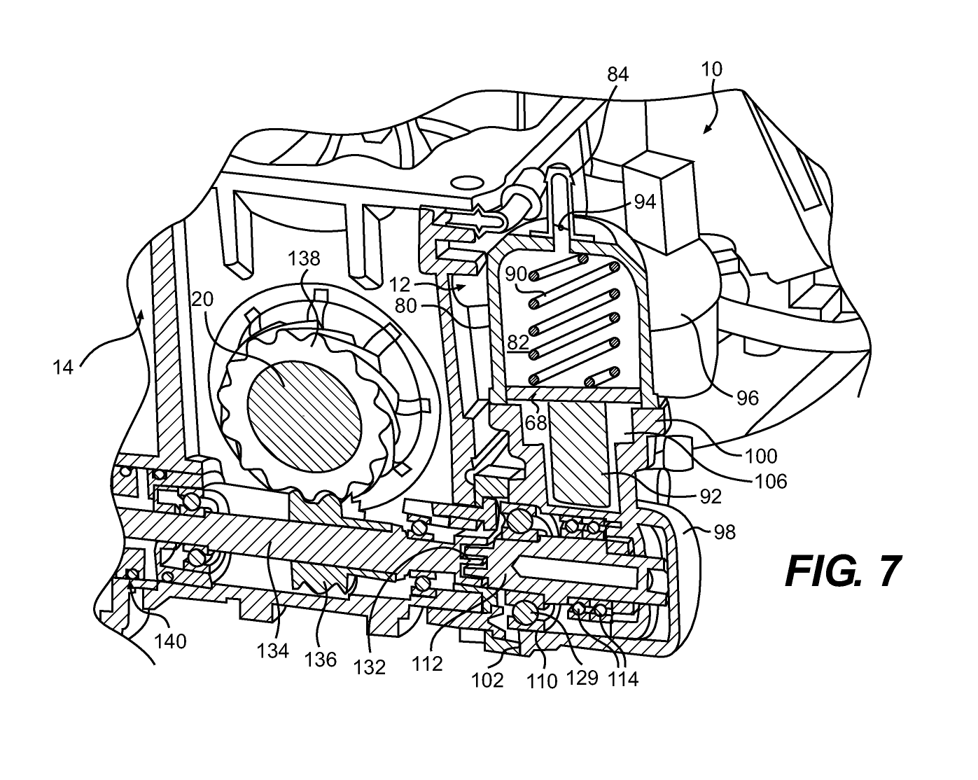

Turning now to FIGS. 2 to 4, and more specifically FIG. 7, the fuel pump 12 will be described. As can be seen in FIG. 7, the fuel pump 12 has a housing 80 defining therein a pump chamber 82. A fuel inlet port 84 of the fuel pump 12 is disposed on top of the housing 80 and a fuel outlet port 86 (best seen in FIG. 2) defined on a side of the housing 80. A pump piston 88 is disposed inside the pump chamber 82 to reciprocate therein. A spring 90 biases the pump piston 88 away from the fuel inlet port 84. A plunger 92 is connected to the bottom of the pump piston 88. The plunger 92 is driven by the pump driving mechanism described below. As it is being driven, the plunger 92 moves up and down which causes the pump piston 88 to also move up and down. An intake valve 94 is disposed inside the fuel inlet port 84. As the pump piston 88 moves down, the intake valve 94 is opened to let fuel enter the pump chamber 82. As the pump piston 88 moves up, the intake valve 94 is closed. This causes the fuel pressure to increase as the pump piston 88 moves up. A pressure regulator 96 connected to the pump housing 80 controls the opening and closing of the intake valve 94 based on a signal received from the ECU. The signal sent by the ECU to the pressure regulator 96 indicates to the pressure regulator 96 when the intake valve 94 should be closed as the pump piston 88 moves up in order to obtain the desired fuel pressure to be supplied to the fuel injectors 32 determined by the ECU. As the pump piston 88 moves up, the intake valve 94 is initially opened, thus allowing fuel in the pump chamber 82 to exit the pump chamber 82 via the fuel inlet port 84 and preventing the fuel pressure from increasing, at least not significantly, as the pump piston 88 moves up. The pressure regulator 96 then closes the intake valve 94 at the time determined based on the signal received from the ECU and fuel pressure increases as the pump piston 88 completes its upward stroke. Therefore, the amount of fuel pressure generated by the fuel pump 12 can be controlled to be at any value (within the fuel pump's operating parameters) by adjusting a closing time of the intake valve 84. As should be understood, the maximum fuel pressure that can be generated by the fuel pump 12 is obtained by maintaining the intake valve 14 closed for the entire upward stroke of the pump piston 88. In one embodiment, the maximum fuel pressure that can be generated by the fuel pump 12 per stroke is about 15 bar. From the fuel pump 12, fuel is supplied to the fuel line 48 via the fuel outlet port 86. The fuel pressure to be supplied to the fuel injectors 32 can be any pressure between a minimum pressure of 20 bar and a maximum pressure exceeding 200 bar. This pressure is achieved over multiple strokes of the fuel pump 12.

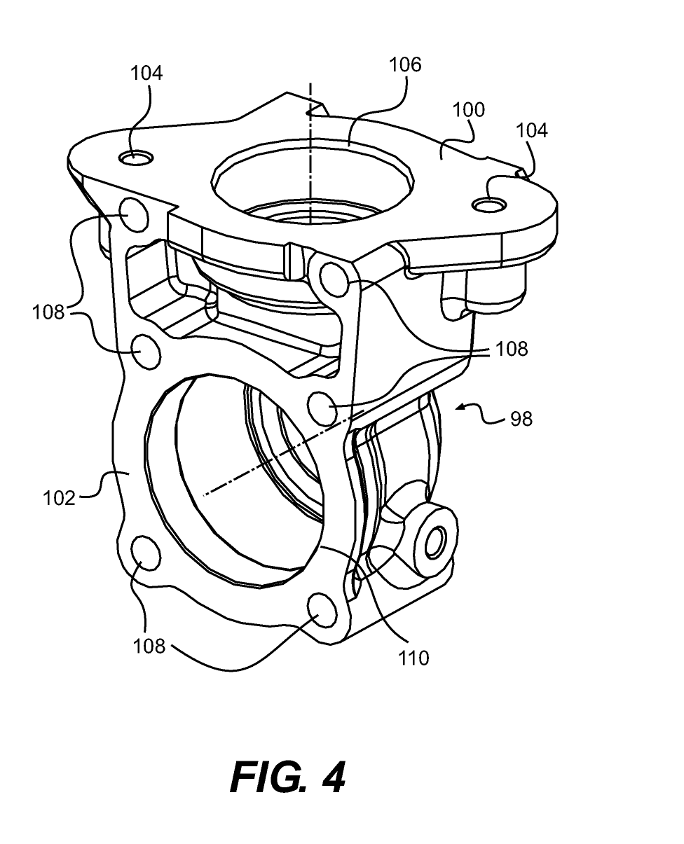

As can be seen in FIG. 2, the fuel pump 12 is connected to a side of the crankcase 14 via a pump mount 98. As best seen in FIG. 4, the pump mount 98 has an upper flange 100 to which the fuel pump 12 is fastened and a crankcase mounting face 102 facing the crankcase 14 when the pump mount 98 is connected to the crankcase 14. The upper flange 100 has apertures 104 to receive the fasteners used to connect the fuel pump 12 to the pump mount 98. The upper flange 100 also defines an aperture 106 that receives the plunger 92 of the fuel pump 12 (see FIG. 7). The crankcase mounting face 102 has apertures 108 to receive the fasteners used to connect the pump mount 98 to the crankcase 14. The crankcase mounting face 102 also defines an aperture 110 to receive the pump driving mechanism described below (see FIG. 7).

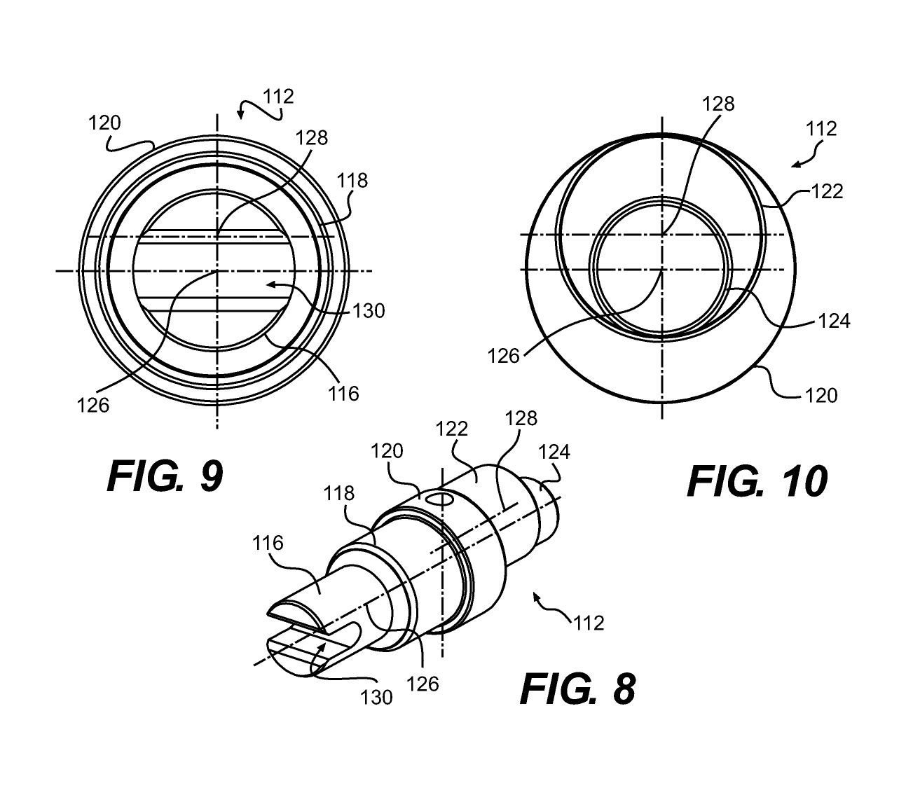

Turning now to FIGS. 7 to 10, a first embodiment of the pump driving mechanism will be described. The first embodiment of the pump driving mechanism includes an eccentric shaft 112 and a pair of ball bearings 114. It is contemplated that only one or more than two ball bearings 114 could be used. As best seen in FIGS. 8 to 10, the eccentric shaft 112 has five cylindrical surfaces 116, 118, 120, 122 and 124 each having different diameters. It is contemplated that the eccentric shaft 112 could have more or less than five cylindrical surfaces and that at least some of the surfaces could have the same diameter. The cylindrical surfaces 116, 118, 120, and 124 have a common central axis 126. The cylindrical surface 122 has a central axis 128 which is offset from the central axis 126. The ball bearings 114 are disposed on the eccentric shaft 112 such that their inner races are disposed around the cylindrical surface 122. The outer races of the ball bearings 114 abut the end of the plunger 92. As seen in FIG. 7, the eccentric shaft 112 is supported in the pump mount 98 by a ball bearing 129 disposed between the cylindrical surface 118 and the aperture 110.

A groove 130 is defined in the end of the eccentric shaft 112. As seen in FIG. 7, the groove 130 is engaged by a tongue 132 defined in an end of a water pump shaft 134. It is contemplated that other types of connections could be provided between the eccentric shaft 112 and the water pump shaft 134, such as a splined or conical connection for example. The water pump shaft 134 is disposed perpendicularly to the crankshaft 20 and is coaxial with the central axis 126 of the eccentric shaft 112. The water pump shaft 134 is driven by the crankshaft 20 via helical gears 136 and 138 disposed on the water pump shaft 134 and the crankshaft 20 respectively. As such, the water pump shaft 134 drives the eccentric shaft 112 and, as its name suggests, a water pump 140 disposed in the crankcase 14. It is contemplated that the eccentric shaft 112 could be driven by any other rotating shaft of the engine 10 such as the crankshaft 20 or the balancer shaft (not shown).

As the eccentric shaft 112 rotates about the central axis 126, the ball bearings 114 move up and down since they are disposed on the cylindrical surface 122. This causes the plunger 92 to move up and down with the ball bearings 114, which operates the fuel pump 112. As mentioned above, the end of the plunger 92 abuts the outer races the ball bearings 114. As the eccentric shaft 112 rotates, the inner races of the ball bearings 114 rotate with the cylindrical surface 122, but the friction forces between the end of the plunger 92 and the outer races of the ball bearings 114 are sufficient to maintain the outer races rotationally stationary. It is contemplated that some rotation of the outer races of the ball bearings could occur, however the speed of rotation of the outer races would be much less than a speed of rotation of the eccentric shaft 112. Since there is no, or very little, relative motion between the end of the plunger 92 and the outer races of the ball bearings 114, the fuel pump 12 can be driven with no, or very little, wear of the end of the plunger 92 and with no or very little side forces applied to the plunger 92.

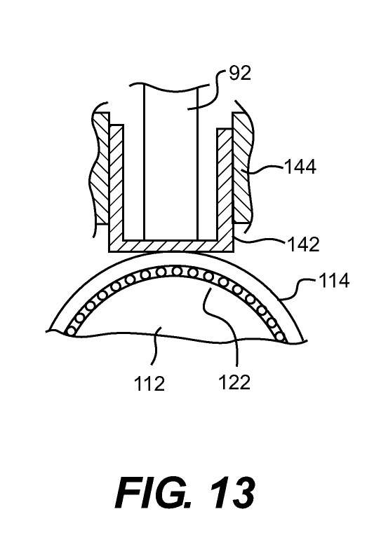

As seen in FIG. 13, it is contemplated that a tappet 142 could be disposed between the end of the plunger 92 and the outer races of the bearings 114, thus preventing wear of the end of the plunger 92. Also, since the tappet 142 is held in a guide 144 which prevents lateral movement of the tappet 142, the application of side forces to the plunger 92 is prevented.

In order to be able to properly control the opening and closing of the intake valve 94 of the fuel pump 12 as described above, the ECU needs to determine the position of the pump piston 88 inside the pump chamber 82. As such, the gears 136 and 138 are preferably selected such that the crankshaft 20 and the pump shaft 134 rotate at the same speed, and therefore the eccentric shaft 112 rotates at the same speed as the crankshaft 20. In this manner, the position of the pump piston 88 inside the pump chamber 82 can be determined using the sensor (not shown) used to sense a speed of rotation of the engine 10. Alternatively, a dedicated sensor could be provided to determine the position of the pump piston 88. Alternatively, it is contemplated that the gears 136 and 138 could be selected such that the pump shaft 134 rotates at half or double speed of the crankshaft 20.

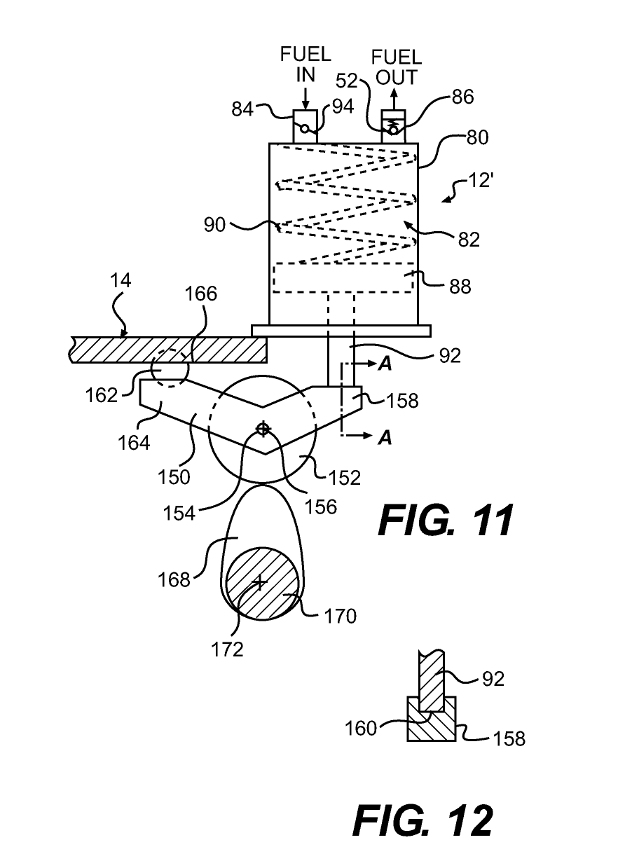

Turning now to FIGS. 11 and 12 a second embodiment of the pump driving mechanism will be described. The second embodiment of the pump driving mechanism drives a fuel pump 12′. The fuel pump 12′ is similar to the fuel pump 12 except that its fuel exhaust port 86 is disposed on the top of the pump housing 80 and has the check valve 52 disposed in the fuel exhaust port 86. As such the fuel pump 12′ operates in the same manner as the fuel pump 12 and, for simplicity, its operation will therefore not be described again. Also for simplicity, the components of the fuel pump 12′ similar to those of the fuel pump 12 have been labelled with the same reference numerals as those of the fuel pump 12 and will not be described again.

The second embodiment of the pump driving mechanism includes a generally V-shaped lever 150 rotatably mounted on a roller 152 via a shaft 154 defining an axis 156. As seen in FIG. 12, one end 158 of the lever 150 has a recessed portion 160 that receives the end of the plunger 92 therein. A ball 162, preferably made of steel, is disposed between the other end 164 of the lever 150 and a surface 166 of the crankcase 14, or of another portion of the engine 10. The roller 152 abuts a cam 168 disposed on a balancer shaft 170 of the engine 10 having an axis of rotation 172. The balancer shaft 170 is driven by and is disposed parallel to the crankshaft 20. It is contemplated that the cam could be disposed on any other rotating shaft of the engine 10 such as the crankshaft 20 or the water pump shaft 134.

As the cam 168 rotates with the balancer shaft 170, the roller 152 moves up and down, which moves the end 158 of the lever 150 up and down and as a result, operates the pump 12′. The shaft 154 moves inside a groove (not shown) in order to control the movement of the roller 152. Since the plunger 92 pushes down on the end 158 of the lever due to the bias of the spring 90, the end 164 of the lever 150 pushes up on the ball 162, thus retaining the ball 162 between the end 164 of the lever 150 and the surface 166 and maintaining contact between the plunger 92 and the end 158. The movement of the end 158 of the lever 150 resulting from this arrangement provides very little relative motion between the end of the plunger 92 and the end 158 of the lever 150. As a result the fuel pump 12′ can be driven with very little wear of the end of the plunger 92 and with very little side forces applied to the plunger 92. It is contemplated that a tappet similar to the tappet 142 described above with respect to FIG. 13 could be disposed between the end of the plunger 92 and the end 158 of the lever 150 to prevent side forces from being applied to the plunger 92.

Modifications and improvements to the above-described embodiments of the present invention may become apparent to those skilled in the art. The foregoing description is intended to be exemplary rather than limiting. The scope of the present invention is therefore intended to be limited solely by the scope of the appended claims.

What is claimed is:

1. An internal combustion engine comprising:
at least one cylinder;
at least one piston disposed in the cylinder, the at least one cylinder and the at least one piston defining at least in part at least one combustion chamber;
a crankshaft operatively connected to the at least one piston;
at least one fuel injector fluidly communicating with the at least one combustion chamber;
a fuel pump fluidly communicating with the at least one fuel injector, the fuel pump including:
a pump piston movable between a first and a second position;
a plunger connected to the pump piston; and
a spring biasing the pump piston toward the first position;
an eccentric shaft having a first cylindrical surface having a first central axis and a second cylindrical surface having a second central axis, the second central axis being offset from the first central axis, the eccentric shaft being operatively driven by the crankshaft such that the eccentric shaft rotates about the first central axis; and
at least one bearing having an inner race disposed on the eccentric shaft around the second cylindrical surface and an outer race abutting an end of the plunger such that as the eccentric shaft rotates, the at least one bearing moves the pump piston between the first and the second position.

2. The engine of claim 1, wherein the eccentric shaft has a third cylindrical surface having a third central axis, the third central axis being co-axial with the first central axis; and
wherein the second cylindrical surface is disposed between the first and the third cylindrical surfaces.

3. The engine of claim 1, further comprising a shaft operatively connected to the crankshaft and disposed generally perpendicular to the crankshaft; and
wherein the eccentric shaft is operatively driven by the shaft.

4. The engine of claim 3, wherein the eccentric shaft is coaxial with the shaft.

5. The engine of claim 3, further comprising a water pump driven by the shaft.

6. The engine of claim 1, wherein the eccentric shaft and the crankshaft rotate at a same speed.

7. The engine of claim 1, wherein the fuel pump is a high pressure fuel pump adapted to pressurize fuel at a pressure exceeding 70 bar.

8. The engine of claim 7, wherein the fuel pump is adapted to pressurize fuel between a minimum pressure of 20 bar and a maximum pressure exceeding 200 bar.

9. The engine of claim 7, wherein the engine is a direct fuel injection two-stroke engine.

10. The engine of claim 1, wherein:
the at least one cylinder is at least two cylinders;
the at least one piston is at least two pistons;
the at least one combustion chamber is at least two combustion chambers; and
the at least one fuel injector is at least two fuel injectors;
the engine further comprising a fuel rail having one inlet fluidly connected to the fuel pump and at least two outlets fluidly connected to the at least two fuel injectors.

11. The engine of claim 1, wherein the fuel pump includes an intake valve for opening and closing a fuel inlet port of the fuel pump; and
wherein an amount of fuel pressure generated by the fuel pump is controlled by adjusting a closing time of the intake valve.

12. The engine of claim 1, further comprising:
a fuel line fluidly communicating the fuel pump with the at least one fuel injector; and
a control valve fluidly communicating with the fuel line;
wherein the control valve fluidly communicates the fuel line with a fuel tank when the pressure of fuel being supplied to the at least one fuel injector is above a desired fuel pressure.

13. The engine of claim 1, further comprising:
a fuel line fluidly communicating the fuel pump with the at least one fuel injector; and
an other fuel injector fluidly connected to the fuel line, the other injector pumping fuel away from the fuel line to a fuel tank when the pressure of fuel being supplied to the at least one fuel injector is above a desired fuel pressure.

14. An internal combustion engine comprising:
at least one cylinder;
at least one piston disposed in the cylinder, the at least one cylinder and the at least one piston defining at least in part at least one combustion chamber;
a crankshaft operatively connected to the at least one piston;
at least one fuel injector fluidly communicating with the at least one combustion chamber;
a fuel pump fluidly communicating with the at least one fuel injector, the fuel pump including:
a pump piston movable between a first and a second position;
a plunger connected to the pump piston; and
a spring biasing the pump piston toward the first position;
a cam being operatively driven by the crankshaft such that the cam rotates about a first axis;
a roller abutting the cam such that the cam moves the roller between a third and a fourth position as the cam rotates; and
a lever rotatably connected to the roller about a second axis, the lever having a first end abutting an end of the plunger such that as the cam moves the roller between the third and the fourth position, the first end of the lever moves the pump piston between the first and the second position.

15. The engine of claim 14, wherein the lever has a second end extending on a side of the second axis opposite the first end of the lever, the second end of the lever pushing against a surface of the engine as the cam moves the roller between the third and the fourth position.

16. The engine of claim 15, further comprising a ball disposed between the second end of the lever and the surface of the engine.

17. The engine of claim 14, wherein the first end of the lever has a recessed portion, and the end of the plunger is received in the recessed portion.

18. The engine of claim 14, further comprising a balancer shaft operatively connected to the crankshaft; and
wherein the cam is disposed on the balancer shaft.

19. The engine of claim 14, wherein the fuel pump is a high pressure fuel pump adapted to pressurize fuel at a pressure exceeding 70 bar.

20. The engine of claim 19, wherein the fuel pump is adapted to pressurize fuel between a minimum pressure of 20 bar and a maximum pressure exceeding 200 bar.

21. The engine of claim 19, wherein the engine is a direct fuel injection two-stroke engine.

22. The engine of claim 14, wherein:
the at least one cylinder is at least two cylinders;
the at least one piston is at least two pistons;
the at least one combustion chamber is at least two combustion chambers; and
the at least one fuel injector is at least two fuel injectors;
the engine further comprising a fuel rail having one inlet fluidly connected to the fuel pump and at least two outlets fluidly connected to the at least two fuel injectors.

23. The engine of claim 14, wherein the fuel pump includes an intake valve for opening and closing a fuel inlet port of the fuel pump; and
wherein an amount of fuel pressure generated by the fuel pump is controlled by adjusting a closing time of the intake valve.

24. The engine of claim 14, further comprising:
a fuel line fluidly communicating the fuel pump with the at least one fuel injector; and
a control valve fluidly communicating with the fuel line;
wherein the control valve fluidly communicates the fuel line with a fuel tank when the pressure of fuel being supplied to the at least one fuel injector is above a desired fuel pressure.

25. The engine of claim 24, further comprising:
a fuel line fluidly communicating the fuel pump with the at least one fuel injector; and
an other fuel injector fluidly connected to the fuel line, the other injector pumping fuel away from the fuel line to a fuel tank when the pressure of fuel being supplied to the at least one fuel injector is above a desired fuel pressure.
